(19) United States
(12) Patent Application Publication
(10) Pub. No.: US 2004/0083259 A1
(43) Pub. Date: Apr. 29, 2004

(54) Method for integrating electronic mail and worldwide web communications with a user

(75) Inventor: Samuel Sergio Tenembaum, Punta Del Este (UY)

Correspondence Address: DARBY & DARBY P.C., P. O. BOX 5257, NEW YORK, NY, 10150-5257, US

(73) Assignee: United Virtualities, Inc., New York, NY (US)

(21) Appl. No.: 10/688,054

(22) Filed: Oct. 17, 2003

Related U.S. Application Data
(63) Continuation of application No. PCT/US02/11958, filed on Apr. 16, 2002.
(60) Provisional application No. 60/283,973, filed on Apr. 16, 2001.

(51) Int. Cl. G06F 15/16

(52) U.S. Cl. 709/201

(57) ABSTRACT

A method is provided for integrating e-mail and browser communications with the user in a computer network including a user's computer and a control server connected for communication, the user's computer running an e-mail program and a browser program. In an initial HTML e-mail communication with the user over the network, a signal is embedded which, upon operation of the HTML on the user's computer, causes transmission to the control server of an ID code signal available at the user's computer and uniquely associated with the user or his computer and, upon receiving the ID code signal at the control server, it is stored in association with information related to the user available to the control server. In a subsequent HTML communication with the user over the network, a signal is embedded which, upon operation of the HTML on the user's computer, causes transmission to the control server of the ID code signal, which is received at the control server. After the server receives the ID code signal, it recovers information about the user available to the control server and, using that information, prepares a response for transmission to the user's computer.

### CROSS REFERENCE OF PRIOR APPLICATIONS

This application is a continuation of International Patent Application No. PCT/US02/11958 filed Apr. 16, 2002, which claims the benefit of U.S. Provisional Application No. 60/283,973 filed Apr. 16, 2001, which are both hereby incorporated by reference in their entirety. The International Patent Application was published in English on Oct. 24, 2002 as WO 02/084505 A1 under PCT Article 21(2).

### FIELD OF THE INVENTION

The present invention relates generally to communication between computers and, more particularly, concerns a method for integrating electronic mail and worldwide web communications with a user to enhance the effectiveness of web services and advertising.

### BACKGROUND OF THE INVENTION

Just as computer networks have gained widespread use in business, the Internet (one example of a computer network) has gained widespread use in virtually every aspect of our lives, owing primarily to the popularity of the worldwide web. The internet includes servers (computers), which offer electrical communication to client computers (operated by users) and other servers. The computers involved may range from mainframes to cellular telephones, and they may operate over any conceivable communication medium.

Most users connect to the Internet (or “surf the net”) through a personal computer running an operating system with a graphic user interface (GUI), such as one of the Windows® operating systems. A user communicates over the Internet using a program called a “browser” running on his computer, the two most popular ones being Internet Explorer and Netscape, although many other browsers are in common use. The browser receives files in a format known as HTML, which is a mark-up language that permits multimedia to be embedded within formatted and stylized text, and it displays “pages”, which may play sound and exhibit graphics and video. Various programming languages, such as Javascript, are also available which permit executable code to be embedded in an HTML file and to run and to perform useful tasks when a browser presents the file to the user. Those skilled in the art will appreciate that browsers are not limited to use on the Internet, but are now widely used for general communication on networks, including intranets.

The widest use of the Internet today is probably as a medium for electronic mail (“e-mail”). Few people living in modern societies today are not aware what e-mail is, if they are not actively making use of it.

It is common today for web browsers and e-mail programs to share their basic functionality. For example, they can both render HTML pages, execute scripts, and interact with web and application servers, in addition to reading and writing cookies. As a result, e-mail and browsing programs often share resources on a user's computer. As an example, Microsoft's Internet Explorer and Outlook programs both share the same HTML rendering engine and plug-ins. Similarly, the e-mail and browsing modules of Netscape Navigator/Communicator share resources on the user's computer.

The present invention permits a user to be recognized at the server end during both his e-mail and browsing activities. As a result, stored information about the user maybe used to enhance and customize his overall online experience. This makes it possible for on-line marketers and content providers to unify strategies, combine information, optimize resources, and streamline management and reporting related to their users. For example, the following enhancements become available in both e-mail and on the web:

Better targeting, granularity and relevancy (consolidation of both sources of information);

Aggregation of Opt-in resources;

Selection of relevant messages in a dynamic fashion, using the latest data available at the time of exposure;

Integration of e-mail and web creative strategies;

Reporting integration;

Campaign customization down to the user level; and

Follow-up on the web of communications initiated by an e-mail, and visa versa.

In accordance with the present invention a method is provided for integrating e-mail and browser communications with the user in a computer network including a user's computer and a control server connected for communication, the user's computer running an e-mail program and a browser program. In an initial HTML e-mail communication with the user over the network, a signal is embedded which, upon operation of the HTML on the user's computer, causes transmission to the control server of an ID code signal available at the user's computer and uniquely associated with the user or his computer and, upon receiving the ID code signal at the control server, it is stored in association with information related to the user available to the control server. In a subsequent HTML communication with the user over the network, a signal is embedded which, upon operation of the HTML on the user's computer, causes transmission to the control server of the ID code signal, which is received at the control server. After the server receives the ID code signal, it recovers information about the user available to the control server and, using that information, prepares a response for transmission to the user's computer.

A cookie is a small file hosted on a user's computer, which stores information about the user. A cookie can be stored or “set” in the user's machine by a server during an HTTP session between them, and the cookie can be read and recorded by a server during a subsequent HTTP session with the user. HTTP sessions are established when a HTML document is executed by either a browser or a HTML e-mail reader.

The present invention makes use of the fact that integrated browser/e-mail packages, such as Netscape Communicator and Microsoft Explorer/Outlook share their cookies. Specifically, in accordance with the present invention, a cookie is used as a point of triangulation in order to identify a user in both the e-mail and web browsing environments, making it possible to discover far more about a user's Internet activities and preferences.

A first level of sophistication achieved by integrating communications in e-mail and web browsing is the possibility to follow up in one medium on a communication initiated in the other medium. For example, an advertisement delivered by e-mail could be followed up with a message for the same product when the user is encountered on a website.

The second level of sophistication is achieved by integrating the e-mail database into the message selection process. As a result, information in the database can be used to select or dynamically generate a customized message for the user, for example, an e-mail advertisement that uses his name or mentions a particular interest.

A third level of sophistication is achieved after the first time an HTML e-mail message is executed by a user. From then on, a user identification code stored in the cookie can be used to customize all communications with the user anywhere on the web, not only e-mail communications. For example, if the mailing list included users' birthdays, if a user were encountered on the web on his birthday, he could be given a sponsored greeting wishing him a happy birthday.

### BRIEF DESCRIPTION OF THE DRAWINGS

The foregoing brief description, as well as further objects, features and advantages of the present invention will be understood more completely from the following detailed description of a preferred embodiment of the invention, with reference being had to the accompanying drawings, in which:

FIG. 1 is a functional block diagram illustrating the environment of the present invention;

FIG. 2 is a functional block diagram illustrating the use of the present invention to locate a user on the Internet;

FIG. 3 is a functional block diagram illustrating the operation of the preferred embodiment of the invention during e-mail communications; and

FIG. 4 is a functional block diagram illustrating web message selection and serving.

### DETAILED DESCRIPTION OF THE PREFERRED EMBODIMENT

The preferred embodiment of the present invention utilizes cookies as a “point of triangulation” for sharing information about a user between web browser and e-mail programs. However, the system described should be considered as merely illustrative and, by no means, the only technical solution for realizing the invention. Other techniques triangulating on an identification code could be used for sharing information, such as the use of hardware identifications (e.g. MacAdresses, and processor identification numbers). It should also be appreciated that such “point of triangulation” can reside either on the user's computer or in a remote server. In the present embodiment it resides on the user's computer in the form of a cookie.

In the preferred embodiment, the invention is described in the context of providing on-line advertising. The primary control computer involved would therefore be described as an advertising server or “ad server.” However, it will be appreciated that there are many other applications for the present invention.

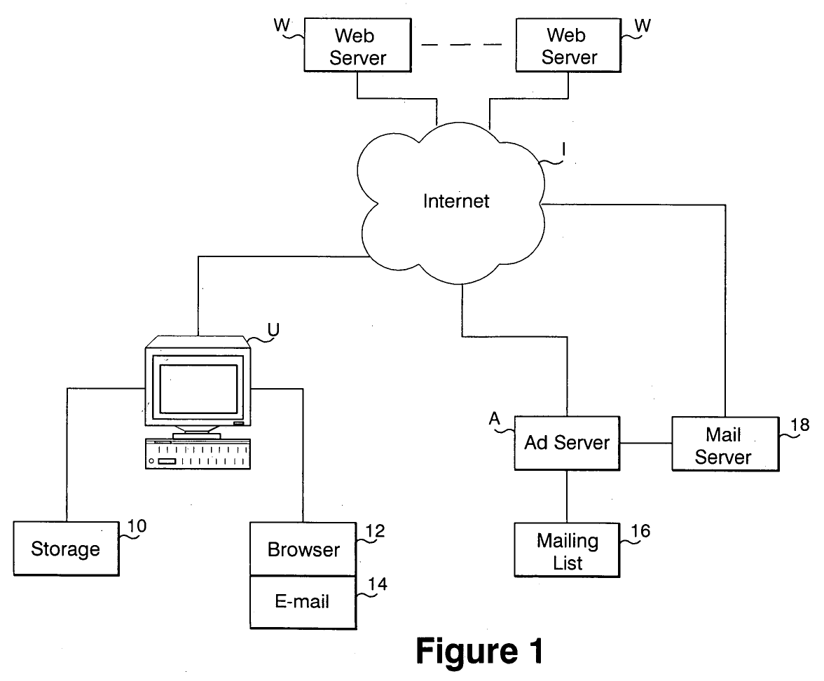

FIG. 1 is a functional block diagram illustrating the environment of the present invention. A plurality of web servers W (computers), user's computers (one user's computer U being shown), and an add server A are connected to the internet I and are capable of intercommunication therethrough. As is typical, the user's computer contains storage 10, such as a hard disk drive, and it is assumed to be running a browser program 12 and an e-mail program 14, which are capable of sharing cookies. The ad server A stores a mailing list which, among other information, includes information about a user of computer U, and HTML e-mail containing advertising will be sent to those on the mailing list through a mail server 18, connected to the internet. The mailing list associates a unique identification code with each addressee.

Through this system utilizing the invention, an HTML e-mail sent to and responded to by user U will eventually result in a cookie being stored in his storage 10 which has his unique identification code in it. Thereafter, when the user communicates with a web server W and makes a commercial inquiry, that inquiry is directed to ad server A, which reads the user's unique identification code stored in the cookie and is able to identify and recognize the user. Server A can therefore provide customized advertising to the user and store any information about the state of his advertising program (in the cookie or elsewhere). The user U will similarly be recognized in future e-mail communications.

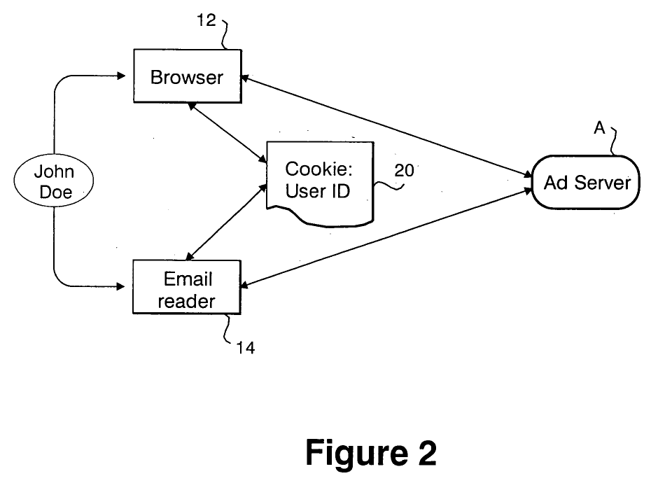

This triangulation process is illustrated in FIG. 2. A user “John Doe”, works on a computer which has a browser program 12 and a e-mail reader program 14. These two programs are capable of sharing cookies. A cookie 20 which contains a unique code “user ID” associated with the user can therefore be accessed through either browser 12 or e-mail reader 14. When John Doe makes commercial inquires through either his browser or e-mail reader, server A is able to recognize the individual through the ID code and provide customized responses, as well as updating the cookie to keep track of the progress of an advertising program.

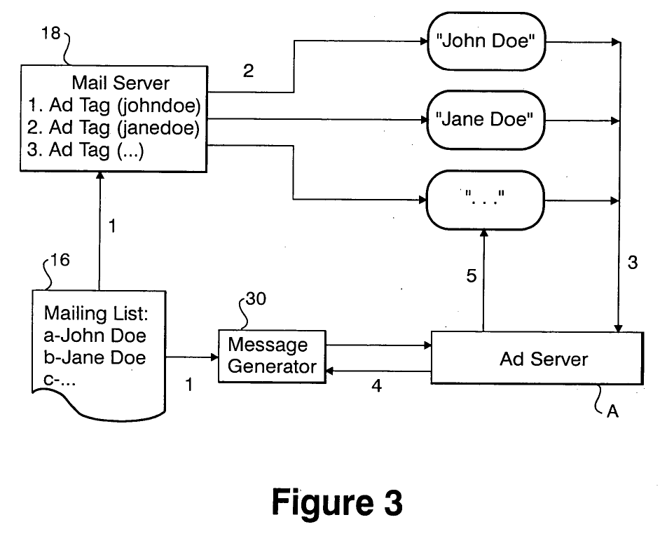

FIG. 3 is a functional block diagram illustrating the operation of the preferred embodiment of the invention during e-mail communications. In a first communication 1, the mailing list 16 stored in ad server A is provided to the mail server 18 and a message generator server 30. The mailing list has a unique ID code associated with each mail addressee. For example, John Doe has the code “a” and Jane Doe “b.” Message generator 30 produces all of the messages and provides them to mail server 18 for transmission to the addressees. The HTML e-mails sent out by mail server 18 include a tag “Ad tag” which contains a variable with the respective user's unique ID codes. The transmission of the e-mails is communication 2. When a user reads the e-mail, the HTML mail is executed, executable code embedded therein requests an ad from ad server A (communication 3) during the negotiation between ad server A and the user, and the user ID code is transmitted to the ad server. Using the ID code, ad server A obtains the identity of the user from the mailing list and uses it to formulate a campaign strategy for the user, and it creates a cookie (which includes user history).

Ad server A then communicates with message generator server 30 (communication 4), and an appropriate message is selected or generated and delivered to ad server A. Ad server A then delivers the message to the user (communication 5). The message includes code which causes a cookie to be saved on the user's machine and to include the user's ID code. In the first communication, the cookie is set, but thereafter it would be updated with the latest information about the user and would overwrite the old cookie.

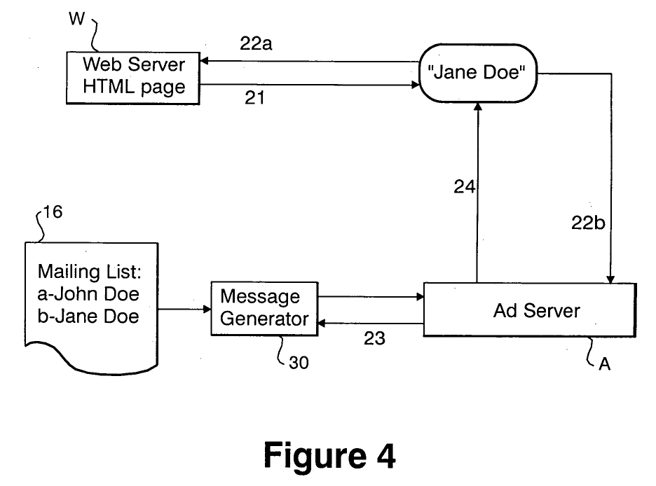

FIG. 4 is a functional block diagram illustrating web message selection and serving. When a user requests a page from a web server W, he receives the page HTML, including an embedded ad tag (communication 21). As the HTML code on the page is executed, the user's browser requests media files from web server W (communication 22a) and an advertisement from ad server A (communication 22b). During the negotiations between ad server A and the user, the cookie saved on the user's computer is accessed and the user ID code is transmitted to ad server A (part of communication 22b). Ad server A is then able to identify the user from the mailing list and to derive his campaign strategy. A request for an appropriate message is then made to message generator 30 (communication 23). The delivered message is then combined with an updated cookie (which includes user history) and transmitted to the user (communication 24). Upon receiving the message, and executing the HTML code, the user's computer overwrites the existing cookie with the updated cookie which also includes the user's ID code.

It should be appreciated that, after the first web communication, the user's computer will always contain a cookie which includes his unique ID code, and that cookie is updated after each web communication to reflect the status of the advertising campaign customized for the user.

Although preferred embodiments of the invention have been disclosed for illustrative purposes, those skilled in the art will appreciate that many additions, modifications and substitutions are possible, without departing from the scope and spirit of the invention as defined by the accompanying claims.

What is claimed:

1. In a computer network including a user's computer and a control server connected for communication, the user's computer running an e-mail program and a browser program, a method for integrating e-mail and browser communications with the user, comprising the steps of:
in an initial HTML e-mail communication with the user over the network, embedding a signal which, upon operation of the HTML on the user's computer, causes transmission to the control server of an ID code signal available at the user's computer and uniquely associated with the user or his computer and, upon receiving the ID code signal at the control server, storing it at the server in association with information related to the user available to the control server;
in a subsequent HTML communication with the user over the network, embedding a signal which, upon operation of the HTML on the user's computer, causes transmission to the control server of the ID code signal and receiving the same at the control server; and
making use of the ID code signal, recovering information about the user available to the control server and, using that information, preparing a response for transmission to the user's computer.

2. The method of claim 1, wherein the e-mail program and browser program can both read and write cookies, the ID code signal being saved on the user's computer in a cookie.

3. The method of claim 2, wherein the cookie is created at the control server and is updated after an HTML communication from the user to the control server, is sent to the user's computer in response to the HTML communication, and is saved therein.

4. The method of claim 1, wherein the control server stores a mailing list containing the identity of users and an ID code signal uniquely identified with each user, the mailing list being used to generate the initial HTML e-mail.

5. The method of claim 3, wherein the cookie contains a history of prior information sent to the user.

6. The method of claim 1, wherein the ID code signal is embedded in the initial HTML e-mail and is transmitted from the user's computer after the initial e-mail is received and opened by the user, the initial HTML e-mail containing executable code which causes the ID code signal to be stored on the user's computer.

7. The method of claim 6, wherein the e-mail program and browser program can both read and write cookies, the ID code signal being saved on the user's computer in a cookie.

8. The method of claim 7, wherein the cookie is created at the control server and is updated after an HTML communication from the user to the control server, is sent to the user's computer in response to the HTML communication, and is saved therein.

9. The method of claim 8, wherein the cookie contains a history of prior information sent to the user.

10. The method of claim 6, wherein the control server stores a mailing list containing the identity of users and an ID code signal uniquely identified with each user, the mailing list being used to generate the initial HTML e-mail.

11. The method of claim 10, wherein the e-mail program and browser program can both read and write cookies, the ID code signal being saved on the user's computer in a cookie.

12. The method of claim 11, wherein the cookie is created at the control server and is updated after an HTML communication from the user to the control server, is sent to the user's computer in response to the HTML communication, and is saved therein.

13. The method of claim 12, wherein the cookie contains a history of prior information sent to the user.

14. The method of claim 10, wherein the control server is an Ad server which provides online advertising to users and selects advertising signals for transmission to a user based on the ID code signal received from the user.

15. The method of claim 14, wherein the control server selects advertising signals for transmission to a user based on information present in the cookie stored on the user's computer.

16. The method of claim 6, wherein the control server is an Ad server which provides online advertising to users and selects advertising signals for transmission to a user based on the ID code signal received from the user.

17. The method of claim 6, wherein the control server selects advertising signals for transmission to a user based on information present in the cookie stored on the user's computer.

18. The method of claim 10, wherein the control server selects advertising signals for transmission to a user based on information present in the cookie stored on the user's computer.
